(19) United States
(12) Patent Application Publication
(10) Pub. No.: US 2006/0273989 A1
(43) Pub. Date: Dec. 7, 2006

(54) Plasma display device and driving method thereof

(76) Inventors: Tae-Seong Kim, Chunan-si (KR); Woo-Joon Chung, Chunan-si (KR); Jin-Ho Yang, Chunan-si (KR); Seong-Joon Jeong, Chunan-si (KR); Suk-Jae Park, Chunan-si (KR)

Correspondence Address: CHRISTIE, PARKER & HALE, LLP, PO BOX 7068, PASADENA, CA, 91109-7068, US

(21) Appl. No.: 11/434,638

(22) Filed: May 15, 2006

(30) Foreign Application Priority Data
Jun. 3, 2005 (KR) 10-2005-0047758

(51) Int. Cl. G09G 3/28

(52) U.S. Cl. 345/67

(57) ABSTRACT

A plasma display device and a driving method thereof. A sustain discharge before a reset period for initializing a cell which is sustain discharged in a previous subfield is generated as a weak discharge rather than a strong discharge. By generating a weak sustain discharge, the amount of wall charge formed in the exterior area of electrodes may be reduced. As a result, in the subsequent reset period, the wall charge can be controlled to be appropriate for addressing while preventing misfiring and low discharge.

### CROSS-REFERENCE TO RELATED APPLICATION

This application claims priority to and the benefit of Korean Patent Application No. 10-2005-0047758 filed in the Korean Intellectual Property Office on Jun. 3, 2005, the entire content of which is incorporated herein by reference.

### BACKGROUND OF THE INVENTION

1. Field of the Invention

The present invention relates to a plasma display device and a driving method thereof.

2. Description of the Related Art

Generally, a driving method of an AC type plasma display device divides a field (frame) into a plurality of subfields. Each subfield may be expressed as operational changes according to time, which include a reset period, an address period, and a sustain period.

The reset period is for initializing the status of each discharge cell so as to facilitate an addressing operation on the discharge cell, and the address period is a period to apply an address voltage to an addressed cell to accumulate wall charges on the addressed cell in order to select a cell to be turned on and a cell not to be turned on in a plasma display panel (PDP). The sustain period is a period to apply sustain pulses to the addressed cell, thereby performing a discharge according to which a picture is actually displayed.

In a conventional driving method of a PDP, a field is divided into eight subfields, and during the reset period of each subfield, waveform of the first subfield and waveforms of the second to the eighth subfield are respectively applied in different forms.

In more detail, during the reset period of the first subfield, a gradually increasing ramp voltage is applied to a scan electrode, and then a gradually decreasing ramp voltage is applied. Thereby, the status of all the discharge cells is initialized. Next, during the reset period of the second subfield, only the gradually decreasing ramp voltage is applied to the scan electrode, so that only the cells discharged in the address period of the first subfield may be reset discharged and initialized. Also during the reset period of the subsequent subfields, the same waveforms as during the reset period of the second subfield are applied. After a sustain period of the eighth subfield, an erase period is provided.

When applying the conventional waveforms described above, since only falling ramp voltage is applied after a sustain discharge of previous subfield during the reset period of the second to the eighth subfield, a wall charge for appropriate addressing is not easily controlled. In more detail, a discharge occurring before the reset period is a strong discharge because it occurs by the sustain discharge. Since there is significant wall charge accumulated in an exterior area (i.e., exterior part of discharge cell formed by electrodes) of each electrode due to the strong discharge, the wall charge may not be controlled appropriately by a reset waveform having only the falling ramp voltage.

FIG. 1A, FIG. 1B and FIG. 1C illustrate the wall charge formed during the sustain period and the wall charge formed during the reset period when applying the conventional driving waveform described above. FIG. 1A shows a wall charge state when the sustain discharge pulse is applied to a sustain electrode. FIG. 1B shows a wall charge state when the last sustain discharge pulse is applied to a scan electrode. FIG. 1C shows a wall charge state after the reset period of the second subfield.

In the sustain period of the first subfield, a strong discharge occurs by a sustain discharge voltage Vs applied to the sustain electrode, and accordingly the wall charge as shown in FIG. 1A is formed. In the last sustain discharge, a relatively high voltage is applied to the scan electrode, and a strong discharge occurs as a sustain discharge. Then, the wall charge as shown in FIG. 1B is formed. As shown in FIG. 1B, significant wall charge is formed also in the exterior area of each electrode by the strong discharge. Therefore, as shown by the dotted lines of FIG. 1C, the wall charge of the exterior area remains when applying the reset waveform having only a falling ramp voltage of the reset period of the second subfield. In other words, the wall charge is not controlled properly. In more detail, the reset discharge by the falling ramp voltage is a weak discharge, and occurs in a near area among each electrode. Therefore, the wall charge of the exterior area of the electrodes is hardly controlled, and remains as shown in FIG. 1C. As described above, when wall charge is not controlled properly during the reset period, a misfiring and a low discharge occur in subsequent addressing.

The above information disclosed in this Background section is only for enhancement of understanding of the background of the invention and therefore, it may contain information that does not form the prior art that is already known in this country to a person or ordinary skill in the art.

### SUMMARY OF THE INVENTION

In accordance with the present invention a plasma display device and a driving method thereof having advantages of preventing a misfiring and low discharge is provided.

An exemplary driving method of a plasma display device including a plurality of first electrodes and second electrodes according to an embodiment of the present invention, the method includes three steps of (a), (b), and (c) noted below.

In the step (a), a sustain discharge occurs during a first period of a sustain period of a first subfield.

In the step (b), during a second period of the sustain period of the first subfield, a voltage difference between the first electrode and its corresponding second electrode, gradually increases from a first voltage differential to a second voltage differential

In the step (c), during a reset period of a second subfield following the first subfield, a voltage, which is given by subtracting a voltage of the second electrode from a voltage of the first electrode, gradually decreases from a third voltage differential to a fourth voltage differential, and thereby a cell discharged during the sustain period of the first subfield is initialized.

In a further embodiment, the second period happens immediately before the reset period of the second subfield.

In another embodiment, the plasma display device further includes a plurality of third electrodes formed in a direction crossing the direction of the first and second electrodes.

Here, during a third period occurring between the first period and the second period, the driving method further includes controlling a voltage difference between the third electrodes and the first electrodes or the second electrodes to be smaller than the voltage difference between the first electrodes and the second electrodes.

In a still further embodiment, during a third period coming between the first period and the second period, the method further includes controlling the voltage between the first and second electrodes to be smaller than a fifth voltage differential, which is a voltage difference between the first and second electrodes during the first period, in order to generate the sustain discharge during the first period.

In a still further embodiment, during the third period, a ground voltage is applied to the first electrode, a sixth voltage lower than the fifth voltage differential is applied to the second electrode, and the voltage difference between the first and second electrodes is controlled to be smaller than the fifth voltage differential.

In a still further embodiment, during the third period, a sixth voltage higher than a ground voltage is applied to the first electrode, the fifth voltage differential is applied to the second electrode, and the voltage difference between the first and second electrodes is controlled to be smaller than the fifth voltage.

In a still further embodiment, during the third period, while applying a sixth voltage to the second electrode, the first electrode is floated at the same time, and the voltage difference between the first and second electrodes is controlled to be smaller than the fifth voltage.

In a still further embodiment, during the second period, while applying a sixth voltage to the second electrode, the voltage of the first electrode is gradually increased to a fifth voltage higher than the sixth voltage, and the voltage difference between the first and second electrodes is gradually increased from the first voltage differential to the second voltage differential.

In a still further embodiment, during the reset period of the second subfield, while applying a seventh voltage to the second electrode, the voltage of the first electrode is gradually decreased to an eighth voltage lower than the fifth voltage, and thereby the initialization of the cell is performed.

In a still further embodiment, the first period and the second period are immediately contiguous in time.

An exemplary driving method of a plasma display device including a plurality of first electrodes and second electrodes according to the present invention, includes three steps (a), (b), and (c) below.

In the step (a), a sustain discharge is performed during a first period of a sustain period of a first subfield.

In the step (b), during a second period of the sustain period of the first subfield, a first voltage differential, which is a voltage difference between the first electrode and the second electrode, is controlled to be smaller than a second voltage differential, which is a difference between a voltage applied to the first electrode and a voltage applied to the second electrode, in order to generate the sustain discharge during the first period.

In the step (c), during a reset period of a second subfield following the first subfield, a third voltage differential, which is given by subtracting a voltage of the second electrode from a voltage of the first electrode, gradually decreases from a fourth voltage level to a fifth voltage level, and a cell discharged during the sustain period of the first subfield is initialized.

In a further embodiment, the second period and the reset period of the second subfield are immediately contiguous in time.

In another embodiment, during a third period between the first period and the second period, the method further includes increasing gradually the first voltage differential.

In a still further embodiment, during the second period, a fifth voltage lower than the second voltage differential and a ground voltage are respectively applied to the first electrode and the second electrode simultaneously, and thereby the first voltage differential is controlled to be smaller than the second voltage differential.

In a still further embodiment, during the second period, a voltage equal to the second voltage differential and a fifth voltage higher than a ground voltage are respectively applied to the first electrode and the second electrode simultaneously, and thereby the first voltage differential is controlled to be smaller than the second voltage differential.

In a still further embodiment, during the second period, while applying a voltage equal in level to the second voltage differential to the first electrode, the second electrode is floated at the same time, and thereby the first voltage differential is controlled to be smaller than the second voltage differential.

In a still further embodiment, the plasma display device further includes a plurality of third electrodes formed in a direction crossing the direction of the first and second electrodes.

Here, during a third period coming between the first period and the second period, the driving method further includes controlling a voltage difference between the third electrode and the first or the second electrodes to be smaller than the first voltage differential.

An exemplary driving method of plasma display device including a plurality of first electrodes and second electrodes, and a plurality of third electrodes formed in a direction crossing the direction of the first and second electrodes according to the present invention, includes three steps of (a), (b), and (c) below.

In the step (a), a sustain discharge is performed during a first period of a sustain period of a first subfield.

In the step (b), during a second period of the sustain period of the first subfield, a first voltage differential, which is a voltage difference between the third electrode and the first or the second electrodes, is controlled to be smaller than a second voltage differential, which is a voltage difference between the first electrode and the second electrode.

In the step (c), during a reset period of a second subfield following after the first subfield, a third voltage differential, which is given by subtracting a voltage of the second electrode from a voltage of the first electrode, gradually decreases from a fourth voltage level to a fifth voltage level, and thereby a cell discharged during the sustain period of the first subfield is initialized.

In a further embodiment, the second period and the reset period of the second subfield are immediately adjacent in time.

In another embodiment, the first voltage differential is a voltage difference between a voltage applied to the first electrode and a voltage applied to the second electrode, that is substantially sufficient to generate the sustain discharge during the first period.

In a still further embodiment, a sixth voltage level is applied to the third electrode during the first period and a seventh voltage level higher than the sixth voltage level is applied to the third electrode during the second period.

In a still further embodiment, during a third period between the first period and the second period, the method further includes gradually increasing the second voltage differential.

In a still further embodiment, during a third period between the first period and the second period, the method further includes controlling the second voltage differential to be smaller than a voltage difference between a voltage applied to the first electrode and a voltage applied to the second electrode in order to generate the sustain discharge during the first period.

An exemplary plasma display device according to an embodiment of the present invention includes a plasma display panel, a controller, and a driver.

The plasma display panel forms a plurality of discharge cells.

The controller controls the device by driving it during frames of time where each frame is divided into a plurality of subfields each including a reset period, an address period, and a sustain period.

The driver generates at least one first sustain discharge having a first magnitude by applying a first sustain discharge waveform to the discharge cell during a first period of a sustain period of a first subfield.

The driver generates at least one second sustain discharge having a second magnitude smaller than the first magnitude by applying a second sustain discharge waveform to the discharge cell during a second period of the sustain period of the first subfield.

The driver generates a reset discharge in the discharge cell, in which the sustain discharge has occurred during the sustain period of the first subfield, by applying a reset waveform to the discharge cell during a reset period of a second subfield following the first subfield.

In a further embodiment, the plasma display panel includes a plurality of scan electrodes and sustain electrodes that are arranged in pairs, and the second sustain discharge waveform allows a voltage difference between a scan electrode and its corresponding sustain electrode to increase gradually.

In another embodiment, the plasma display panel includes a plurality of scan electrodes and sustain electrodes, and the second sustain discharge waveform allows a first voltage, which is a voltage difference between a scan electrode and a corresponding sustain electrode, to be lower than a second voltage, which is a voltage difference between the scan electrode and the corresponding sustain electrode during the first period.

In a still further embodiment, a third voltage lower than the second voltage and a ground voltage are respectively applied to the scan electrode and the sustain electrode simultaneously, and thereby the first voltage is controlled to be lower than the second voltage.

In a still further embodiment, the second voltage and a third voltage higher than a ground voltage are respectively applied to the scan electrode and the sustain electrode simultaneously, and thereby the first voltage is controlled to be lower than the second voltage.

In a still further embodiment, while applying a third voltage to the scan electrode, the sustain electrode is floated and thereby the first voltage is controlled to be lower than the second voltage.

In a still further embodiment, the plasma display panel includes a plurality of scan electrodes and sustain electrodes that are arranged in pairs, and a plurality of address electrodes formed in a direction crossing a common direction of the first and second electrodes. A second sustain discharge waveform allows a voltage difference between the address electrode and a corresponding scan or sustain electrode to be smaller than a voltage difference between a pair of scan and sustain electrodes.

In a still further embodiment, the second period and the reset period of the second subfield are immediately contiguous in time.

### BRIEF DESCRIPTION OF THE DRAWINGS

FIGS. 1A, 1B and 1C illustrate wall charges formed during a sustain period and during a reset period which are formed by the conventional driving waveforms.

FIG. 2 is a schematic plan view showing a plasma display device according to an exemplary embodiment of the present invention.

FIG. 3 illustrates a driving waveform of the plasma display device according to a first exemplary embodiment of the present invention.

FIGS. 4A, 4B and 4C illustrate wall charge formed on each electrode when a waveform as shown in FIG. 3 is applied.

FIG. 5 illustrates a driving waveform of the plasma display device according to a second exemplary embodiment of the present invention.

FIG. 6 illustrates a driving waveform of the plasma display device according to a third exemplary embodiment of the present invention.

FIG. 7 illustrates a driving waveform of the plasma display device according to a fourth exemplary embodiment of the present invention.

FIG. 8 illustrates a driving waveform of the plasma display device according to a fifth exemplary embodiment of the present invention.

FIG. 9 illustrates a driving waveform of the plasma display device according to a sixth exemplary embodiment of the present invention.

### DETAILED DESCRIPTION OF THE EMBODIMENTS

A wall charge mentioned in the present invention means charges formed and accumulated on a wall (e.g., a dielectric layer) close to an electrode of a discharge cell. Although the wall charges do not actually touch the electrodes, herein the wall charge will be described as being “formed” or “accumulated” on the electrode. A wall voltage means a potential difference formed on a wall of a cell by the wall charge.

Referring now to FIG. 2, the plasma display device according to an exemplary embodiment of the present invention includes a PDP 100, a controller 200, an address electrode driver 300, a scan electrode driver 400, and a sustain electrode driver 500.

The PDP 100 includes a plurality of address electrodes A1 to Am extending in a column direction, and pluralities of sustain electrodes X1 to Xn and scan electrodes Y1 to Yn extending in a row direction in pairs. Generally, the sustain electrodes X1 to Xn are formed in correspondence to the respective scan electrodes Y1 to Yn, and respective ends thereof are coupled to each other. The PDP 100 includes a substrate in which the sustain and scan electrodes (i.e., X1 to Xn, Y1 to Yn) are arranged (not shown), and another substrate in which the address electrodes A1 to Am are arranged (not shown). The two substrates are placed facing each other with a discharge space therebetween so that the directions of the scan electrodes Y1 to Yn and the address electrodes A1 to Am may perpendicularly cross each other, and the directions of the sustain electrodes X1 to Xn and the address electrodes A1 to Am may perpendicularly cross each other. Here, the discharge space formed at a crossing region of the directions of the address electrodes A1 to Am and the sustain and scan electrodes X1 to Xn, and Y1 to Yn forms a discharge cell. This structure of the PDP 100 is exemplary, and PDPs having other structures, to which the various driving waveforms to be described below can be applied, can be used in the present invention.

The controller 200 receives an external video signal, and outputs an address electrode driving control signal 600, a sustain electrode driving control signal 700, and a scan electrode driving control signal 800. The controller 200 controls the plasma display device by dividing a frame into a plurality of subfields each having their own respective brightness weight values. Each subfield may be expressed as operational changes according to time, which include a reset period, an address period, and a sustain period.

The address electrode driver 300 receives the address electrode driving control signal 600 from the controller 200, and applies a display data signal for selecting discharge cells to be discharged to the address electrodes.

The sustain electrode driver 400 receives the sustain electrode driving control signal 700 from the controller 200, and applies a driving voltage to the sustain electrodes X.

The scan electrode driver 500 receives the scan electrode driving control signal 800 from the controller 200, and applies the driving voltage to the scan electrodes Y.

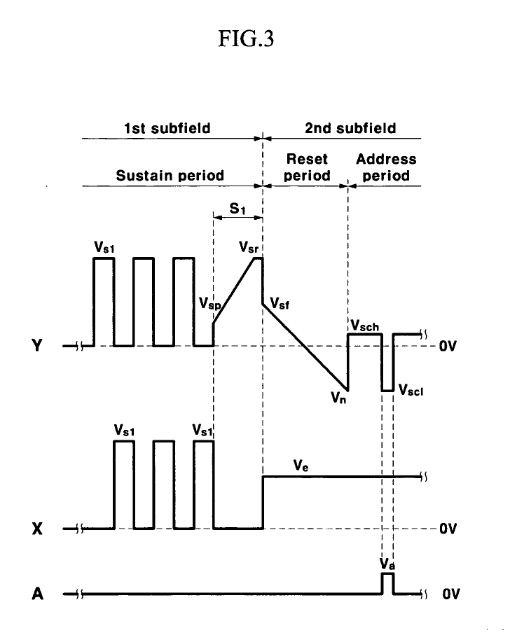

Hereinafter, referring to FIG. 3 to FIG. 9, driving waveforms of the plasma display device applied to the address electrodes A1-Am, the sustain electrodes X1-Xn, and the scan electrodes Y1-Yn according to exemplary embodiments of the present invention will be described in more detail. Notations of reference labels as address electrode A, scan electrode Y, and sustain electrodes X represent that the same voltage is applied to all the address electrodes, all the scan electrodes, and all the sustain electrodes, and notations of reference labels as address electrodes Aᵢ and scan electrodes Yⱼ represent that a corresponding voltage is applied to some of the address electrodes and the scan electrodes. The sustain period to be described below represents a period for performing a discharge in order to display an image in a discharge cell selected during the address period.

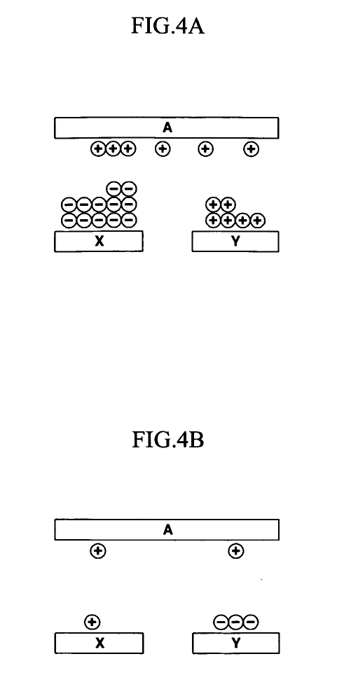

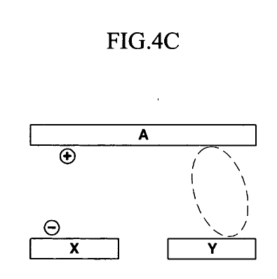

FIG. 3 illustrates the driving waveform of the plasma display device according to the first exemplary embodiment of the present invention. FIG. 4A, FIG. 4B and FIG. 4C illustrate the wall charge formed on each electrode when the waveform shown in FIG. 3 is applied. FIG. 3 just shows a driving waveform applied during the sustain period of a first subfield which is an arbitrary subfield and a driving waveform applied during the reset period and address period of a second subfield following the first subfield. Other parts of the driving waveform are omitted.

In the sustain period of the first subfield, a sustain discharge pulse voltage Vs1 is alternately applied to the scan electrode Y and the sustain electrode X, so that a cell selected in the address period of the first subfield may be sustain discharged. When the sustain discharge pulse voltage Vs1 is applied to the sustain electrode X, wall charges are formed in the discharge cell shown in FIG. 4A. In more detail, when applying the sustain discharge pulse voltage Vs1 to the sustain electrode X and applying a reference voltage (hereinafter, assumed to be 0V) to the scan electrode Y, a strong discharge occurs. Then a large amount of negative (−) wall charge is formed widely in the sustain electrode X, and a large amount of positive (+) wall charge is formed widely in the scan electrode Y and the address electrode A. Next, in a period S1 for generation of the last sustain discharge, a voltage of the scan electrode Y is gradually increased from voltage Vsp to voltage Vsr while applying the reference voltage 0V to the sustain electrode X. Then, a weak discharge occurs from the scan electrode Y to the sustain electrode X, and as shown in FIG. 4B, the wall charges formed on the exterior area of each electrode is reduced. Generally, since the weak discharge is not diffused to the entire area of the electrode, less wall charge is formed in the exterior area of the electrode. As shown in FIG. 3, when applying the gradually increasing voltage to the scan electrode Y for a sustain discharge, the weak discharge occurs and less wall charge is formed in the exterior area of the electrode. The voltage Vsp is set to have a proper value to prevent a strong discharge caused by the wall charge generated in the previous sustain discharge before applying of the voltage Vsp. The voltage Vsr allows only the discharge cell selected in the address period of the first subfield (not shown) to sustain discharge, and is set to have a proper value for this. The voltage Vsr may be set to be the same as the voltage Vs1 in order to decrease the number of sources required for generating voltage.

In the subsequent reset period of the second subfield, the voltage of the scan electrode Y is gradually decreased from a voltage Vsf to a voltage Vn while applying a voltage Ve to the sustain electrode X. Then, a weak reset discharge occurs only in the discharge cells which are selected and sustain discharged in the first subfield, but not in the other selected discharge cells. As shown in FIG. 4B, in the cell in which the sustain discharge occurs in the first subfield, the wall charge is hardly formed in the exterior area of the electrodes. Accordingly, as shown in FIG. 4C, even applying merely the gradually decreasing voltage of the reset period in the second subfield, effectively controls the wall charges. As a result, an appropriate state of the wall charge for a subsequent addressing operation can be provided by applying only the gradually decreasing voltage of the waveform of the reset period in the second subfield. This is all possible because the last sustain discharge of the first subfield is a weak discharge rather than a strong discharge. So, as shown in FIG. 4B, the wall charge is hardly formed in the exterior area of the electrode. Consequently, only a weak discharge in the interior area of the electrode is sufficient to clear the wall charges and reset the discharge cell.

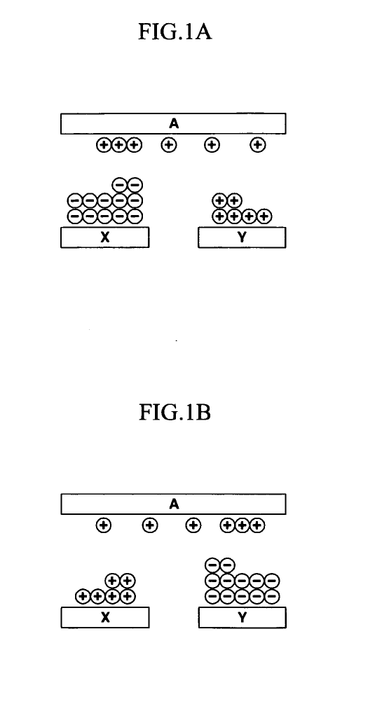

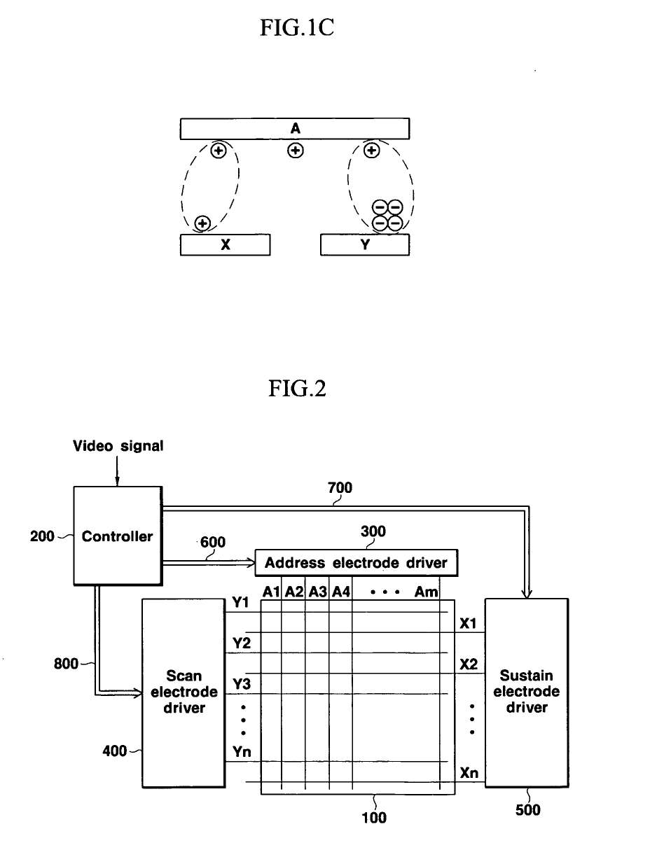

Therefore, according to the first exemplary embodiment of the present invention as shown in FIG. 4C, in contrast to the case of FIG. 1C, the wall charge is hardly formed in the exterior area of the electrode, and the appropriate wall charge for addressing is formed even during the reset period. Consequently, according to the first exemplary embodiment of the present invention, misfiring and low discharge in the address period may be prevented.

In the address period of the second subfield, a scan pulse having a voltage Vscl is sequentially applied to the scan electrode Yj to select a discharge cell, scan electrodes to which voltage Vscl is not applied are biased with voltage Vsch. Here, the voltage Vscl is called a scan voltage, and the voltage Vsch is called a non-scan voltage. An address pulse having a voltage Va is applied to the address electrode Ai forming a discharge cell to be selected from a plurality of discharge cells formed by the scan electrode to which the voltage Vscl is applied. The address electrodes corresponding to discharge cells that are not selected are biased with the reference voltage 0V. Then, in the discharge cell formed by the address electrode to which the voltage Va is applied and the scan electrode to which the voltage Vscl is applied, an address discharge occurs, a positive (+) wall charge is formed on the scan electrode Y1, and a negative (−) wall charge is formed on the sustain electrode X1.

According to the first exemplary embodiment of the present invention, when generating the weak discharge rather than the strong discharge for the last sustain discharge during the sustain period of the previous subfield, less wall charge is formed in the exterior area of the sustain and scan electrodes. Therefore, even a reset discharge brought about by applying the gradually decreasing voltage during the reset period, can form the proper wall charge for addressing.

Other embodiments of the present invention provide other methods for generating a weak discharge instead of a strong discharge to form less wall charges in the exterior area of the electrode. Hereinafter, the other embodiments will be described in detail.

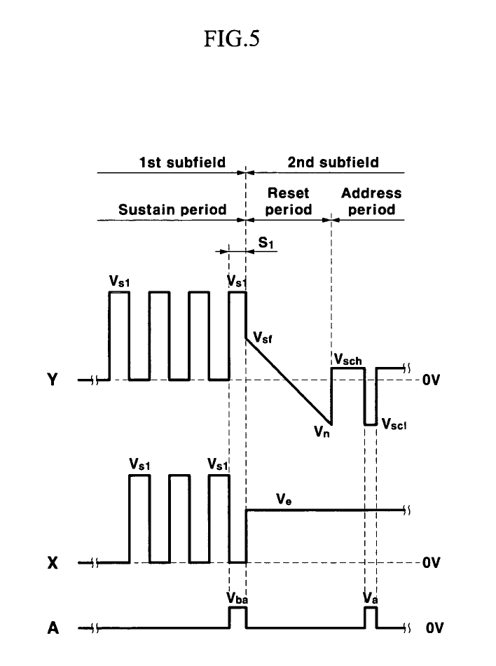

FIG. 5 illustrates a driving waveform of the plasma display device according to the second exemplary embodiment of the present invention. The driving waveform according to the second exemplary embodiment of the present invention is equivalent to the driving waveform according to the first exemplary embodiment of the present invention except that the last sustain discharge pulse voltage Vs1 is applied to the scan electrode Y during the sustain period of the first subfield while a voltage Vba is applied to the address electrode A at the same time. In other words, in a period S1 in which the last sustain discharge is generated, while applying the reference voltage 0V to the sustain electrode X, the last sustain discharge pulse voltage Vs1 is applied to the scan electrode Y, and at the same time, the voltage Vba higher that the reference voltage is applied to the address electrode A. Then, a voltage difference between the scan electrode Y and the address electrode A becomes small, and a sustain discharge which is a weak discharge occurs. Accordingly, similar to the first exemplary embodiment, the wall charge formed in the exterior area of each electrode Y, X and A becomes smaller. Therefore, as in the first exemplary embodiment, during the reset period of the second subfield which occurs when less wall charge is formed in the exterior area of the electrodes, it is possible to control the proper wall charge for addressing even when applying the gradually decreasing voltage to the scan electrode Y in reset period. Consequently, misfiring and low discharge in the address period can be prevented. The voltage Vba may be set to be substantially the same as the address voltage Va applied in the address period.

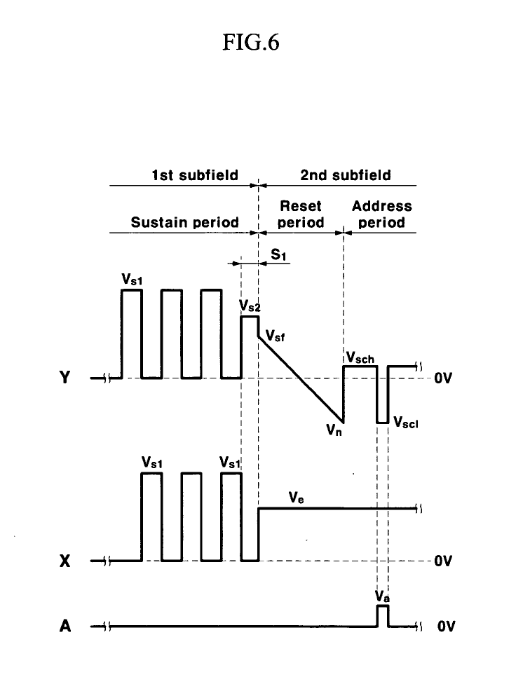

FIG. 6 illustrates a driving waveform of the plasma display device according to a third exemplary embodiment of the present invention. The driving waveform according to the third exemplary embodiment of the present invention is equivalent to the driving waveform according to the first exemplary embodiment of the present invention except that a voltage Vs2 lower than the voltage Vs1 is applied to the scan electrode Y as the last sustain discharge pulse during the sustain period of the first subfield. In more detail, in order to make the last sustain discharge a weak discharge rather than a strong discharge, while applying the reference voltage 0V to the sustain electrode X in a period S1, the voltage Vs2 which is lower than the voltage Vs1 is applied to the scan electrode Y. Here, the address electrode A is maintained to be the reference voltage 0V. Then, a voltage difference between the scan electrode Y and the sustain electrode X becomes smaller than a voltage difference in a previous sustain discharge, and a weak discharge occurs. Accordingly, as in the first exemplary embodiment, less wall charge is formed in the exterior area of the electrode. Therefore, it is possible to control the proper wall charge for addressing during the reset period of the second subfield which occurs in the state that less wall charge is formed in the exterior area of the electrode, even when applying the gradually decreasing voltage to the scan electrode Y in this reset period. Consequently, misfiring and low discharge in the address period can be prevented. The voltage Vs2 should be properly set in order to generate the weak discharge between the scan electrode Y and the sustain electrode X.

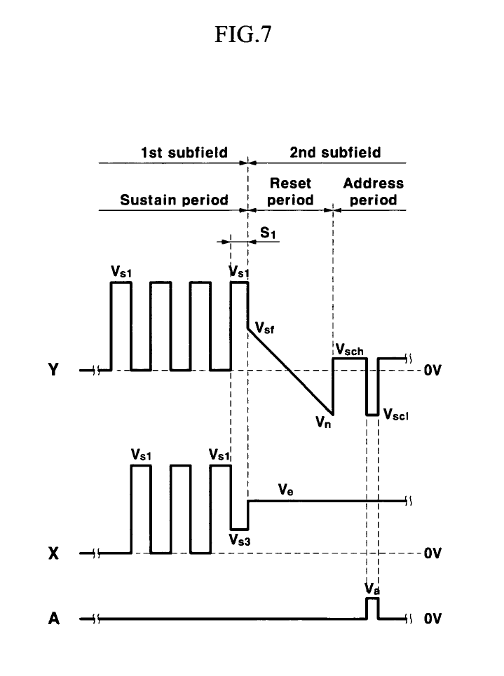

FIG. 7 illustrates a driving waveform of the plasma display device according to a fourth exemplary embodiment of the present invention. The driving waveform according to the fourth exemplary embodiment of the present invention is equivalent to the driving waveform according to the first exemplary embodiment of the present invention except that the last sustain discharge pulse voltage Vs1 is applied to the scan electrode Y during the sustain period of the first subfield while a voltage Vs3 higher than the reference voltage 0V is applied to the sustain electrode X at the same time. This combination generates a weak discharge as the last sustain discharge. In more detail, in order to make the last sustain discharge a weak discharge rather than a strong discharge, while applying the voltage Vs3 which is higher than the reference voltage 0V to sustain electrode X in a period S1, the sustain discharge pulse voltage Vs1 is applied to the scan electrode Y. Here, the address electrode A is maintained to be the reference voltage 0V. Then, a voltage difference between the scan electrode Y and the sustain electrode X (i.e., Vs1-Vs3) becomes smaller than a voltage difference in a previous sustain discharge (i.e., Vs1-0), and a weak discharge occurs. Accordingly, as in the first exemplary embodiment, less wall charge is formed in the exterior area of the electrode. Therefore, as in the first exemplary embodiment, during the reset period of the second subfield which occurs in the state that less wall charge is formed in the exterior area of the electrode, even when applying the gradually decreasing voltage to the scan electrode Y in reset period, it is possible to control the proper wall charge for addressing. Consequently, misfiring and low discharge in the address period can be prevented. Here, the voltage Vs3 should be properly set in order to generate the weak discharge between the scan electrode Y and the sustain electrode X.

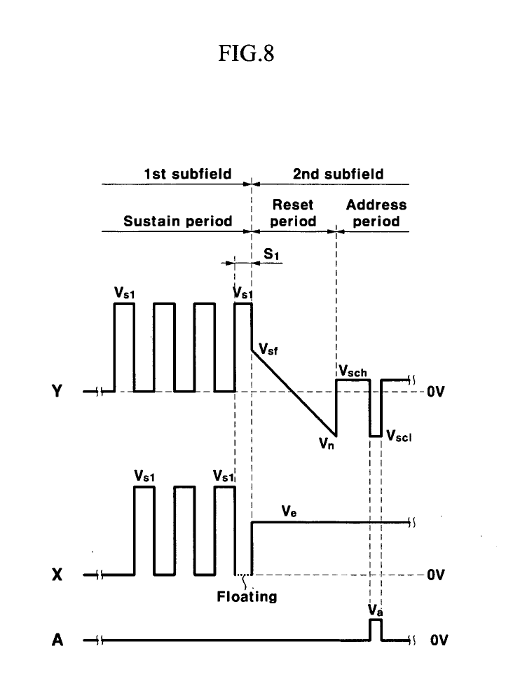

FIG. 8 illustrates a driving waveform of the plasma display device according to a fifth exemplary embodiment of the present invention. The driving waveform according to the fifth exemplary embodiment of the present invention is equivalent to the driving waveform according to the first exemplary embodiment of the present invention except that the last sustain discharge pulse voltage Vs1 is applied to the scan electrode Y during the sustain period of the first subfield while the sustain electrode is controlled to be floated at the same time, in order to generate the last sustain discharge as a weak discharge. In more detail, in order to make the last sustain discharge a weak discharge rather than a strong discharge, while the sustain electrode is controlled to be floated, the sustain discharge pulse voltage Vs1 is applied to the scan electrode Y at the same time. Here, the address electrode A is maintained to be the reference voltage 0V. When controlling the sustain electrode X to be floated, the voltage of the sustain electrode X increases after the voltage Vs1 is applied to the scan electrode Y, and a voltage difference between the scan electrode Y and the sustain electrode X decreases. Accordingly, a weak discharge occurs between the scan electrode Y and the sustain electrode X. Due to this weak discharge, the wall charge formed in the exterior area of the electrodes may be decreased, during the reset period of the second subfield that follows the first subfield. Consequently, even when applying the gradually decreasing voltage to the scan electrode Y in reset period as in the first exemplary embodiment, it is possible to control the proper wall charge for addressing. In the exterior area of the electrodes, the wall charge hardly remains, and this state of the wall charge is appropriate for addressing. Consequently, misfiring and low discharge in the address period can be prevented.

So far, in FIG. 3 and FIG. 5 to FIG. 8, the methods for reducing the amount of wall charge formed in the exterior area of the electrodes by generating a weak discharge in the last sustain discharge have been described in detail. However, it is possible to generate the weak discharge by applying the waveforms as shown in FIG. 3 and the FIG. 5 to FIG. 8 not in the last sustain discharge but in one of the sustain discharges prior to the last, and applying the normal sustain discharge pulse afterward. An equivalent effect may be accomplished in this manner.

Although the methods for easily controlling the wall charge in the following reset period by generating a weak discharge rather than a strong discharge for the last sustain discharge, and reducing the amount of the wall charge formed in the exterior area of the electrodes have been described so far, however, when weakening not only the last sustain discharge but also the sustain discharge just prior to the last, the amount of the wall charge formed in the exterior area of the electrodes may be reduced even more, and the same effect may be accomplished. Hereinafter, such a method will be described in detail.

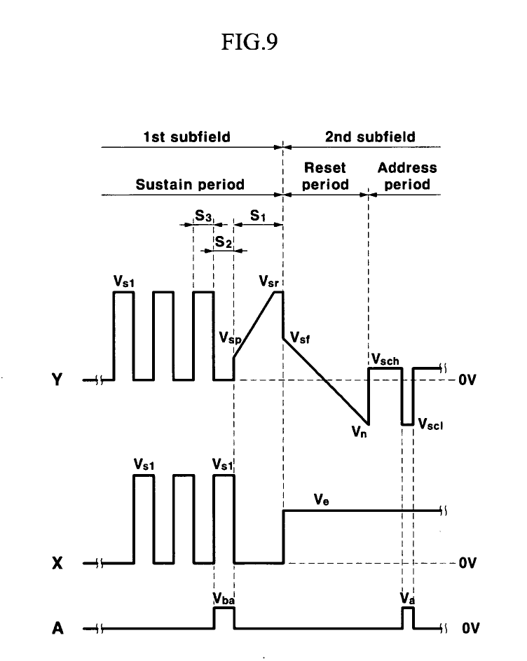

FIG. 9 illustrates a driving waveform of the plasma display device according to a sixth exemplary embodiment of the present invention. The driving waveform according to the sixth exemplary embodiment of the present invention is equivalent to the driving waveform according to the first exemplary embodiment of the present invention except that the last sustain discharge pulse voltage Vs1 is applied to the scan electrode Y during the sustain period of the first subfield while a voltage Vba is applied to the address electrode A at the same time. In other words, in a period S2 preceding the period S1, while applying the reference voltage 0V to the scan electrode Y, the sustain discharge pulse voltage Vs1 is applied to the sustain electrode X, and at the same time, voltage Vba is applied to the address electrode A. Then, a voltage difference between the sustain electrode X and the address electrode A becomes smaller than that in the previous sustain discharge, and a weak discharge occurs. Accordingly, the wall charge formed in the exterior area of the electrodes may be reduced to be less than the wall charges formed as a result of a strong sustain discharge. In a period S1 in which the last sustain discharge occurs, while applying the reference voltage 0V to the sustain electrode X, a voltage gradually increasing from voltage Vsp to voltage Vsr is applied to the scan electrode Y as in the first exemplary embodiment. As a result of this waveform, another weak discharge occurs from the scan electrode Y to the sustain electrode X, and the amount of the wall charge formed in the exterior area of the electrodes X, Y and A may be further reduced. Therefore, during the reset period of the continuing second subfield, control of wall charge by the reset discharge becomes easier, and an appropriate state of the wall charge for addressing can be established.

In the period S2 in which the sustain discharge right before the last sustain discharge (i.e., applying a higher voltage to the sustain electrode X than to the scan electrode Y) occurs, not only the waveform of FIG. 9 but also the waveforms applied in the period S1 shown in FIG. 3, FIG. 6, FIG. 7 and FIG. 8 may be provided to generate a weak discharge rather than a strong discharge. In that case, the waveforms applied in the period S1 shown in FIG. 3, FIG. 6, FIG. 7 and FIG. 8 are applied with being shifted to the sustain electrode X and the scan electrode Y in the period S2. In other words, instead of applying the higher voltage to the scan electrode Y rather than to the sustain electrode X, the higher voltage is applied to the sustain electrode X, and the lower voltage is applied to the scan electrode Y. Thereby, the sustain discharge immediately before the last sustain discharge can be controlled to be a weak discharge.

In addition, in order to control the sustain discharge before the last sustain discharge to be a weak discharge rather than a strong discharge, one of the voltage waveforms applied in the period S1 shown in FIG. 5 to FIG. 8 may be applied in the period S1, and the waveform in the period S1 shown in FIG. 3 may be applied in the period S2. However in this case, the waveform applied to the sustain electrode X and the scan electrode Y in the period S1 shown in FIG. 3 is applied after being shifted to the period S2. Also, by combining the voltage waveforms applied in the period S1 shown in FIG. 5 to FIG. 8, the last sustain discharge and the sustain discharge just prior to the last may be controlled to be a weak discharge.

Moreover, not only the method of generating two succeeding weak sustain discharges as shown in FIG. 9, but also a method of generating three succeeding weak discharges can be provided, so that the wall charge formed in the exterior area of the electrodes may be reduced even more. In more detail, in a period S3 in which the second to last sustain discharge occurs, instead of applying a sustain discharge pulse waveform generating a strong discharge as shown in FIG. 9, the waveform in the period S1 as shown in FIG. 3, FIG. 5, FIG. 6, FIG. 7, or FIG. 8 may be applied in order to generate a weak discharge. Even when generating the weak discharge three times in a row, the waveforms applied in the period S1 shown in the FIG. 3, FIG. 5, FIG. 6, FIG. 7, and FIG. 8 may be combined and applied.

In FIG. 3, and FIG. 5 to FIG. 9, the gradually increasing or decreasing voltage waveforms have been indicated to be a ramp waveform, however a RC resonance waveform, a logarithmic waveform, a step waveform, and other waveforms may be applied also.

As described above, according to the embodiments of the present invention, when generating a weak discharge during the sustain period, the amount of the wall charge formed in the exterior area of the electrodes is decreased, and the wall charge in the following reset period may be controlled to be in a proper state for addressing. Thereby, misfiring and low discharge may be prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving method of a plasma display device having a plurality of pairs of a first electrode and a second electrode, the plasma display device being driven during frames, each frame divided into subfields, each subfield having a reset period, an address period, and a sustain period, the driving method comprising:
during a first period of a sustain period of a first subfield, performing a sustain discharge;
during a second period of the sustain period of the first subfield, the second period following the first period, gradually increasing a voltage difference between the first electrode and the second electrode from a first voltage differential to a second voltage differential; and
during a reset period of a second subfield following the first subfield, initializing a cell discharged during the sustain period of the first subfield by gradually decreasing a voltage obtained by subtracting a voltage of the second electrode from a voltage of the first electrode, from a third voltage differential to a fourth voltage differential.

2. The driving method of claim 1, wherein the second period of the sustain period of the first subfield occurs immediately before the reset period of the second subfield.

3. The driving method of claim 1, wherein the plasma display device further includes a plurality of third electrodes, each third electrode being formed in a direction crossing a direction of the first electrode and the second electrode, the driving method further comprising:
during a third period occurring between the first period and the second period, controlling a voltage difference between the third electrode and the first electrode and a voltage difference between the third electrode and the second electrode to be smaller than the voltage difference between the first electrode and the second electrode.

4. The driving method of claim 1, further comprising:
during a third period occurring between the first period and the second period, controlling the voltage difference between the first electrode and the second electrode to be smaller than a fifth voltage differential, the fifth voltage differential being the voltage difference between the first electrode and the second electrode during the first period for generating the sustain discharge during the first period.

5. The driving method of claim 4, wherein during the third period, the voltage difference between the first electrode and the second electrode is controlled to be smaller than the fifth voltage differential by applying a ground voltage to the first electrode and a sixth voltage level having a value lower than the fifth voltage differential to the second electrode.

6. The driving method of claim 4, wherein during the third period, the voltage difference between the first electrode and the second electrode is controlled to be smaller than the fifth voltage differential, by applying a sixth voltage level higher than a ground voltage to the first electrode, and a voltage level having a value equal to the fifth voltage differential to the second electrode.

7. The driving method of claim 4, wherein during the third period, the voltage difference between the first electrode and the second electrode is controlled to be smaller than the fifth voltage differential, by floating the first electrode while applying a sixth voltage level to the second electrode.

8. The driving method of claim 1, wherein gradually increasing the voltage difference between the first electrode and the second electrode from the first voltage differential to the second voltage differential during the second period includes gradually increasing the voltage of the first electrode to a fifth voltage level higher than a sixth voltage level while applying the sixth voltage level to the second electrode.

9. The driving method of claim 8, wherein the initializing the cell during the reset period of the second subfield includes gradually decreasing the voltage of the first electrode to an eighth voltage level lower than the fifth voltage level while applying a seventh voltage level to the second electrode.

10. The driving method of claim 1, wherein the first period and the second period are immediately adjacent.

11. A driving method of a plasma display device having a plurality of pairs of a first electrode and a second electrode, the method comprising:
during a first period of a sustain period of a first subfield, performing a sustain discharge;
during a second period of the sustain period of the first subfield, controlling a voltage difference between the first electrode and the second electrode to be smaller than the voltage difference between the first electrode and the second electrode during the first period, the voltage difference between the first electrode and the second electrode during the first period being substantially sufficient for performing a sustain discharge; and
during a reset period of a second subfield following the first subfield, initializing a cell discharged during the sustain period of the first subfield by gradually decreasing a voltage differential determined by subtracting a voltage of the second electrode from a voltage of the first electrode.

12. The driving method of claim 11, wherein the second period immediately precedes the reset period of the second subfield.

13. The driving method of claim 11, further comprising:
during a third period occurring between the first period and the second period, gradually increasing the voltage difference between the first electrode and the second electrode.

14. The driving method of claim 11, wherein controlling the voltage difference between the first electrode and the second electrode during the second period of the sustain period of the first subfield to be smaller than the voltage difference between the first electrode and the second electrode during the first period, is performed by:
simultaneously applying a voltage level having a value lower than a first voltage differential to the first electrode and a ground voltage to the second electrode, the first voltage differential being the voltage difference between the first electrode and the second electrode during the first period.

15. The driving method of claim 11, wherein controlling the voltage difference between the first electrode and the second electrode during the second period of the sustain period of the first subfield to be smaller than the voltage difference between the first electrode and the second electrode during the first period, is performed by:
simultaneously applying a first voltage level to the first electrode and a voltage higher than a ground voltage to the second electrode, the first voltage level having a value equal to the voltage difference between the first electrode and the second electrode during the first period.

16. The driving method of claim 11, wherein controlling the voltage difference between the first electrode and the second electrode during the second period of the sustain period of the first subfield to be smaller than the voltage difference between the first electrode and the second electrode during the first period, is performed by:
floating the second electrode while applying a first voltage level to the first electrode, the first voltage level having a value equal to the voltage difference between the first electrode and the second electrode during the first period.

17. The driving method of claim 11, wherein the plasma display device further includes a plurality of third electrodes, each third electrode formed in a direction crossing a direction of the first electrode and the second electrode, the method further comprising:
during a third period occurring between the first period and the second period, controlling a voltage difference between the third electrode and the first electrode and a voltage difference between the third electrode and the second electrode to be smaller than the voltage difference between the first electrode and the second electrode.

18. A driving method of plasma display device having a first electrode, a second electrode, and a third electrode formed in a direction crossing a direction of a pair of a first electrode and a second electrode, the method comprising:
during a first period of a sustain period of a first subfield, performing a sustain discharge;
during a second period of the sustain period of the first subfield, controlling a first voltage differential to be smaller than a second voltage differential, the first voltage differential being a voltage difference between the third electrode and the first electrode or a voltage difference between the third electrode and the second electrode, and the second voltage differential being a voltage difference between the first electrode and the second electrode; and
during a reset period of a second subfield following the first subfield, gradually decreasing a third voltage differential from a fourth voltage level to a fifth voltage level and thereby initializing a cell discharged during the sustain period of the first subfield, the third voltage differential being determined by subtracting a voltage of the second electrode from a voltage of the first electrode.

19. The driving method of claim 18, wherein the second period and the reset period of the second subfield are immediately contiguous.

20. The driving method of claim 18, wherein the second voltage differential is a voltage difference between a voltage applied to the first electrode and a voltage applied to the second electrode to generate the sustain discharge during the first period.

21. The driving method of claim 18, wherein a sixth voltage level is applied to the third electrode during the first period and a seventh voltage level higher than the sixth voltage level is applied to the third electrode during the second period.

22. The driving method of claim 18, further comprising:
during a third period occurring between the first period and the second period, gradually increasing the second voltage differential.

23. The driving method of claim 18, further comprising:
during a third period between the first period and the second period, controlling the second voltage differential to be smaller than a voltage difference between a voltage applied to the first electrode and a voltage applied to the second electrode in order to generate the sustain discharge during the first period.

24. A plasma display device comprising:
a plasma display panel having a discharge cell;
a controller for controlling the device during frames of time, each frame being divided into a plurality of subfields, each subfield having a reset period, an address period, and a sustain period; and
a driver for driving the device by:
generating at least one first sustain discharge having a first magnitude by applying a first sustain discharge waveform to the discharge cell during a first period of a sustain period of a first subfield,
generating at least one second sustain discharge having a second magnitude smaller than the first magnitude by applying a second sustain discharge waveform to the discharge cell during a second period of the sustain period of the first subfield, and
generating a reset discharge in the discharge cell by applying a reset waveform to the discharge cell during a reset period of a second subfield following the first subfield.

25. The plasma display device of claim 24,
wherein the plasma display panel includes a scan electrode and a sustain electrode, and
wherein the second sustain discharge waveform allows a voltage difference between the scan electrode and the sustain electrode to increase gradually.

26. The plasma display device of claim 24,
wherein the plasma display panel includes a scan electrode and a sustain electrode, and
wherein the second sustain discharge waveform controls a first voltage differential to be lower than a second voltage differential, the first voltage differential being a voltage difference between the scan electrode and the sustain electrode during the second period of the sustain period of the first subfield and the second voltage differential being a voltage difference between the scan electrode and the sustain electrode during the first period.

27. The plasma display device of claim 26, wherein the second sustain discharge waveform controls the first voltage differential to be lower than the second voltage differential by simultaneously applying a third voltage having a value smaller than the second voltage differential to the scan electrode and a ground voltage to the sustain electrode.

28. The plasma display device of claim 26, wherein the second sustain discharge waveform controls the first voltage differential to be lower than the second voltage differential by simultaneously applying a third voltage having a value equal to the second voltage differential to the scan electrode and a fourth voltage higher than a ground voltage to the sustain electrode.

29. The plasma display device of claim 26, wherein the second sustain discharge waveform controls the first voltage differential to be lower than the second voltage differential by floating the sustain electrode while applying a third voltage to the scan electrode.

30. The plasma display device of claim 24,
wherein the plasma display panel comprises a plurality of scan electrodes and sustain electrodes, and a plurality of address electrodes formed in a direction crossing a direction of the scan electrodes and the sustain electrodes, and
wherein the second sustain discharge waveform allows a voltage difference between an address electrode and a corresponding scan electrode or a corresponding sustain electrode to be smaller than a voltage difference between the scan electrode and the sustain electrode.

31. The plasma display device of claim 24, wherein the second period and the reset period of the second subfield are immediately contiguous in time.
